(19) United States
(12) Patent Application Publication
(10) Pub. No.: US 2020/0394013 A1
(43) Pub. Date: Dec. 17, 2020

(54) User Interface of Wireless Audio Transmission System

(71) Applicant: JTS PROFESSIONAL CO., LTD., Taichung (TW)

(72) Inventor: Ming-Cheng CHUNG, Taichung (TW)

(21) Appl. No.: 16/443,842

(22) Filed: Jun. 17, 2019

(51) Int. Cl. G06F 3/16; G06F 3/0482

(52) U.S. Cl. CPC G06F 3/16; H04W 72/0453; G06F 3/0482

(57) ABSTRACT

A user interface of a wireless audio transmission system is applicable for any one of wireless monitoring, a wireless microphone, a wireless speaker system, a wireless conference system, a wireless teaching system, and a wireless tour guide system. The wireless audio transmission system contains: a channel menu interface, a channel management module, and an application program module. The channel menu interface is configured to transmit multiple sets of frequencies. The channel management module is coupled with the channel menu interface and includes a channel menu. The application program module is coupled with the channel management module and includes a menu data storage module configured to save the multiple sets of frequencies in the menu data storage module from the channel menu interface, and the multiple sets of frequencies being established as the channel menu by ways of the channel management module.

### FIELD OF THE INVENTION

The present invention relates to a user interface of a wireless audio transmission system which the user selects the channel by using the channel menu and executes audio transmission quickly.

### BACKGROUND OF THE INVENTION

A conventional wireless audio transmission system is applicable for any one of wireless monitoring, a wireless microphone, a wireless teaching system, and a wireless tour guide system. The conventional wireless audio transmission system contains a transmitter configured to transmit a set of frequencies, so it cannot contain an application program and a menu interface integrated with the application program so that a user selects a channel quickly.

The present invention has arisen to mitigate and/or obviate the afore-described disadvantages.

### SUMMARY OF THE INVENTION

The primary objective of the present invention is to provide a user interface of a wireless audio transmission system by which the user selects the channel by using the channel menu and executes audio transmission quickly.

To obtain above-mentioned objective, a user interface of a wireless audio transmission system provided by the present invention is applicable for any one of wireless monitoring, a wireless microphone, a wireless speaker system, a wireless conference system, a wireless teaching system, and a wireless tour guide system.

The wireless audio transmission system contains: a channel menu interface, a channel management module, and an application program module.

The channel menu interface is configured to transmit multiple sets of frequencies.

The channel management module is coupled with the channel menu interface and includes a channel menu.

The application program module is coupled with the channel management module and includes a menu data storage module configured to save the multiple sets of frequencies in the menu data storage module from the channel menu interface, and the multiple sets of frequencies being established as the channel menu by ways of the channel management module.

Preferably, the channel menu interface further includes a search frequency instruction, a frequency establishment channel menu instruction, a channel selection and transmission instruction, and a channel removal instruction.

Preferably, the wireless audio transmission system is a wireless audio receiver or a wireless audio transmitter.

### BRIEF DESCRIPTION OF THE DRAWINGS

FIG. 1 is a block diagram showing the assembly of a wireless audio transmission system according to a preferred embedment of the present invention.

FIG. 2 is a block diagram showing the assembly of a channel menu interface of a user interface of a wireless audio transmission system according to the preferred embedment of the present invention.

### DETAILED DESCRIPTION OF THE PREFERRED EMBODIMENTS

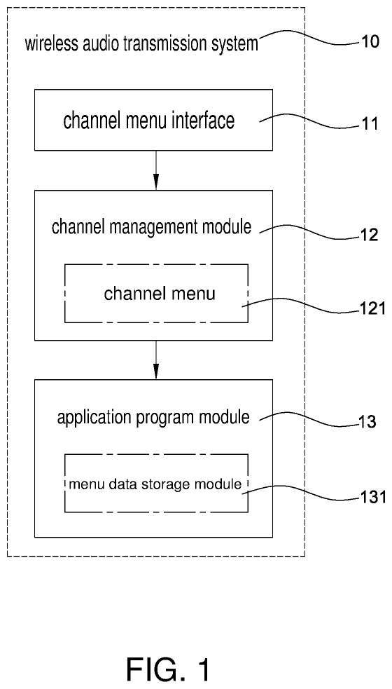

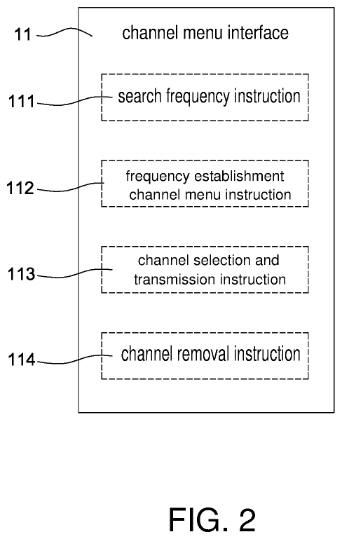

With reference to FIGS. 1-2, a user interface of a wireless audio transmission system 10 according to a preferred embodiment of the present invention is applicable for wireless monitoring, a wireless microphone, a wireless speaker system, a wireless conference system, a wireless teaching system or a wireless tour guide system. The wireless audio transmission system 10 comprises:

a channel menu interface 11 configured to transmit multiple sets of frequencies;

a channel management module 12 coupled with the channel menu interface 11 and including a channel menu 121;

an application program module 13 coupled with the channel management module 12 and including a menu data storage module 131 configured to save the multiple sets of frequencies in the menu data storage module 131 from the channel menu interface 11, and the multiple sets of frequencies being established as the channel menu 121 by ways of the channel management module 12 so that a user selects a channel by using the channel menu 121 and executes audio transmission;

wherein the channel menu interface 11 further includes a search frequency instruction 111, a frequency establishment channel menu instruction 112, a channel selection and transmission instruction 113, and a channel removal instruction 114 which are executed by pressing buttons or by touching keys of a touch screen, wherein the search frequency instruction 111 is configured to search a frequency of a transmitter (not shown) or a frequency of a receiver, the frequency establishment channel menu instruction 112 is configured to establish a sequence of searching frequencies of the transmitter, the channel selection and transmission instruction 113 is configured to let the user select the channel by ways of the channel menu 121 and to execute the audio transmission and audio reception, and the channel removal instruction 114 is configured to let the user remove the channel.

Accordingly, the wireless audio transmission system is capable of transmitting the multiple sets of frequencies by using the channel menu interface 11, saving the multiple sets of frequencies in the menu data storage module 131 in order, establishing the multiple sets of frequencies as the channel menu 121 by ways of the channel management module 12 so that the user selects the channel by using the channel menu 121 and executes audio transmission quickly.

Preferably, the wireless audio transmission system is a wireless audio receiver or a wireless audio transmitter.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A user interface of a wireless audio transmission system being applicable for any one of wireless monitoring, a wireless microphone, a wireless speaker system, a wireless conference system, a wireless teaching system, and a wireless tour guide system, the wireless audio transmission system comprising:
a channel menu interface configured to transmit multiple sets of frequencies;
a channel management module coupled with the channel menu interface and including a channel menu; and
an application program module coupled with the channel management module and including a menu data storage module configured to save the multiple sets of frequencies in the menu data storage module from the channel menu interface, and the multiple sets of frequencies being established as the channel menu by ways of the channel management module;
wherein the channel menu interface further includes a search frequency instruction, a frequency establishment channel menu instruction, a channel selection and transmission instruction, and a channel removal instruction.

2. (canceled)

3. The user interface as claimed in claim 1, wherein the wireless audio transmission system is a wireless audio receiver or a wireless audio transmitter.
